(19) United States
(12) Patent Application Publication
(10) Pub. No.: US 2018/0319688 A1
(43) Pub. Date: Nov. 8, 2018

(54) PRIMARY TREATMENT OF WASTEWATER WITH SWITCHING FROM REAGENT-FREE OPERATION TO OPERATION WITH REAGENT

(71) Applicant: SUEZ INTERNATIONAL, Paris la Dèfense Cedex (FR)

(72) Inventors: Philippe GINESTET, Chateaufort (FR); Magali LE QUINIO, Puteaux (FR)

(21) Appl. No.: 15/775,532

(22) PCT Filed: Nov. 9, 2016
(86) PCT No.: PCT/EP2016/077085

§ 371 Date: May 11, 2018

(30) Foreign Application Priority Data
Nov. 12, 2015 (FR) 1560797

(51) Int. Cl. C02F 9/00

(52) U.S. Cl. CPC C02F 9/00; C02F 2001/007

(57) ABSTRACT

Disclosed is a process for the treatment of urban or industrial wastewater, in particular a process for the primary treatment of water, said process comprising a first operating mode P1 of the treatment system called a “reagent-free mode”, a second operating mode P2 of transition from the first reagent-free mode P1 to a third mode P3, said third operating mode P3 of the treatment system being called a “mode with reagents”, switching from the first mode P1 to the second mode P2, from the second mode P2 to the third mode P3 and from the third mode P3 to the mode P1 being respectively made after verifying a set of conditions C1, C2 and C3.

### TECHNICAL FIELD OF THE INVENTION

The present invention relates to the design of a primary physico-chemical wastewater treatment system by coagulation-flocculation-settling and to its operation during the transition phase from a reagent-free operation to an operation with reagents.

### STATE OF PRIOR ART

The primary wastewater treatment is very often made using a primary treatment facility placed upstream of a biological treatment. According to the biological treatment process, the primary treatment can be “plain” (without adding a coagulation reagent and a flocculation reagent) or “aided” (addition of coagulation, flocculation reagents and potentially ballasting agents).

The conventional or lamella primary settling facilities with reagents can be classified into 3 large families:

reactors without sludge beds,

reactors without sludge beds with ballasting agents (microsand for example),

reactor with sludge bed (recirculation of part of the sludge).

The present invention relates to sludge bed reactors.

Water purification is a set of techniques which consist in purifying water either to recycle sewage in the natural environment, or to transform natural waters into potable water.

Among the different treatments, there is the coagulation-flocculation, a water purification physico-chemical treatment which promotes colloid sedimentation. Firstly, coagulation, in particular by adding metal salts (generally iron or aluminium), enables intercolloidal repulsions to be removed: metal cations (Al³⁺ and Fe³⁺) bind to colloids and neutralise them thereby enabling colloidal particles to meet. Secondly, flocculation makes it possible to cope with the problem of the small diameter of the colloids. The real issue is actually the mass, which does not allow a natural and exploitable sedimentation within the scope of a treatment. The solution exploited by flocculation is to cause, by virtue of the addition of a flocculant, an agglomeration of colloidal particles. Thereafter, this colloid agglomerate called a floc has a sufficient mass to be able to settle. The flocculant added is generally a polymer, whether organic or natural, which will play the role of glue between colloids. The coagulants and flocculants make up so-called reagents.

It is very commonplace that primary treatment facilities with reagents have to operate without reagents in order to save reagents when the station flow rate or load permits it, to increase organic matter supply to the biological stage. Thus, the reagent-free operation (plain settling) can make up the normal case and in case of a higher flow rate (for example, in rainy weather), an operation with reagents is implemented.

When sludge bed reactors switch from a “reagent-free” operation to an operation “with reagents”, a number of vigilance points is to be considered:
the supernatant contains plain settled water, strongly loaded with colloids and suspended matter. At the maximum flow rate, the hydraulic turnover time of the entire facility is generally between 15 and 45 minutes.
the flocculator has not the sufficient contact mass to ensure proper flocculation.
the sludge at the bottom of the facility is not conditioned (namely it does not contain reagent and is thereby not ballasted) and risks:
   if it is recirculated to the flocculator and passes back into the settling zone, to be partly found in the treated water or
   to be pulled out at the bottom upon occurrence of a high flow rate and to partially contaminate treated water.

Indeed, these non-conditioned sludge from a plain settling have generally not a sufficient intrinsic fall velocity to be able to settle at the velocities applied for high flow rates.

To avoid onsets of plain settling sludge upon occurrence of high flow rates, it is generally recommended to discharge them before this occurrence.

That is why today, the procedure implemented before switching from a “reagent-free” operation to an operation “with reagents”, thus involves the forced extraction of non-conditioned primary sludge, in the absence of recirculation, and starting the operation with reagents before the occurrence of high flow rates.

This operation can turn out to be quite long (2 to 5 h) and sometimes incompatible with the abilities to anticipate these events (in terms of time, duration and extent) and treatment and/or storage abilities for these sludge within the facility. This can cause operational and investment extra-costs.

Thus, there is a need for a process making it possible to switch from a “reagent-free” operation to an operation “with reagents”, which is economically cheap while remaining reliable and easy to implement.

### DISCLOSURE OF THE INVENTION

The present invention enables the conditioning of plain settling sludge (for example dry weather sludge) to be implemented with reagents at the beginning of the occurrence of high flow rates (for example, occurrence of rainy weather) rather than to force discharge thereof.

Therefore, one object of the present invention is a process for treating urban or industrial wastewater, in particular a process for the primary treatment of water, said process comprising a first operating mode P1 of the treatment system called a “reagent-free mode”, a second operating mode P2 of transition from the “reagent-free mode” P1 to a third mode P3, said third operating mode P3 of the treatment system being called a “mode with reagents”, switching from the first mode P1 to the second mode P2 being made after verifying a first set of conditions C1, switching from the second mode P2 to the third mode P3 being made after verifying a second set of conditions C2 and switching from the third mode P3 to the first mode P1 being made after verifying a third set of conditions C3.

For the purposes of the present invention, the first operating mode P1 corresponding to an operating mode of the treatment system called a “reagent-free mode”, is an operating mode called a “plain settling” wherein the suspended matter is separated from water only by gravity in the absence of reagents conventionally used as flocculants and coagulants. Water is generally discharged by overflow and the sludge formed is recovered at the bottom of the settling zone and potentially at least one part of the sludge is recirculated to the flocculation zone.

For the purposes of the present invention, the second operating mode P2 is a transition mode or a transition phase enabling the recirculated plain settling sludge to be conditioned with addition of reagents (coagulant and/or flocculant). Thus, preferably, at the end of the second operating mode P2, the sludge circulating in the treatment system is conditioned because it has been in contact with a reagent (coagulant and/or flocculant), preferably coagulant.

For the purposes of the present invention, the third operating mode P3 corresponding to an operating mode of the treatment system called a “mode with reagents” is an operating mode in which a coagulant reagent enables the very fine particles contained in water to be gathered in order to create “flocs”, which are glued together by the action of a flocculant, which enables big “flocs” to be formed, which will be separated much quicker from water to be treated by settling.

In what follows, the terms “coagulant” and “coagulation agent” are equivalent; the terms “flocculant” and “flocculation agent” are also equivalent.

As an example of coagulants, mineral coagulants as iron or aluminium salts and organic coagulants or mixtures thereof can be mentioned. As flocculants, the mineral flocculants (such as activated silica and silicoaluminate), natural and synthetic organic flocculants (polymers) (such as alginates, starches), or mixtures of these different flocculants can be mentioned.

In an advantageous embodiment of the invention, other reagents such as ballasting agents can also be used.

In an advantageous embodiment of the invention, the process further comprises one or more systems for verifying the set of conditions C1, C2 and C3 enabling:

a. the process, when it is in the first mode P1 and that at least one of the conditions of the first set of conditions C1 is not verified, to switch to the second mode P2,

b. the process, when it is in the second mode P2 and that at least one of the conditions of the set of conditions C2 is not verified, to switch to the third mode P3, and

c. the process, when it is in the third mode P3 and that one of the conditions of the third set of conditions C3 is verified, to switch to the first mode P1.

When the process is in the first mode P1 or in the second mode P2 and that all the corresponding conditions are verified, then the process remains in the first mode P1 or in the second mode P2.

Among the parameters making up the conditions C1, C2 and C3, at least the measurement of the water flow rate and/or water quality and/or sludge quality and/or a signal from weather services and/or measurements made upstream in a sanitation system can be mentioned.

According to one embodiment of the invention, the process comprises a step of verifying the set of conditions C1, C2 and C3 enabling:

a. the process, when it is in the first mode P1 and that at least one of the conditions of the first set of conditions C1 is not verified, to switch to the second mode P2,

b. the process, when it is in the second mode P2 and that at least one of the conditions of the second set of conditions C2 is not verified, to switch to the third mode P3, and

c. the process, when it is in the third mode P3 and that one of the conditions of the set of conditions C3 is verified, to switch to the first mode P1.

In accordance with the invention, the operating period of the process in the first mode P1 can comprise:

a) passing raw water to be treated in a so-called coagulation zone in which no coagulant is present, nor injected and then

b) passing water from said coagulation zone into a so-called flocculation zone in which no flocculation agent is present, nor injected and then

c) passing water from said flocculation zone into a so-called settling zone, and then

d) potentially a step of recirculating the plain settling sludge from said settling zone to said flocculation zone by an external circuit, said flocculation zone being located upstream of said settling zone,

and the operating period of the process in the second mode P2 can comprise:

a) either a step of recirculating the plain settling sludge from said settling zone to said coagulation zone by an external circuit, said coagulation zone being located upstream of said settling zone and said coagulation zone receiving a coagulant,

b) or a step of recirculating the plain settling sludge from the settling zone to the raw water inlet point located upstream of the measurement of turbidity (NTU) or suspended matter (SM) of said raw water by an external circuit, said raw water inlet being located upstream of the coagulation zone receiving coagulant,

c) or a step of recirculating the plain settling sludge from said settling zone to said flocculation zone by an external circuit, said circuit receiving coagulant through a coagulant injection system into said circuit, said flocculation zone being located upstream of said settling zone.

It is to be noted that the choice between the abovementioned steps (a), (b) or (c) is made with respect to the dimension of the facility of the sanitation system. The recirculation step (a) corresponds to FIG. 1B, the recirculation step (b) corresponds to FIG. 1C and the recirculation step (c) corresponds to FIG. 1D. The advantage of the recirculation step (b) is that a further SM or NTU measuring means can be dispensed with. However, the drawback of the recirculation step (b) is that it requires the addition of a large size hose to recirculate the plain settling sludge to the raw water inlet point. The advantage of the recirculation step (c) is that there is no structural modification of the sanitation system except for the addition of the coagulant injection hose and a valve (not illustrated in FIG. 1D) between the injection hose and the sludge recirculation loop to stop injecting coagulant upon switching from the operating mode P2 to the operating mode P3. However, the drawback of the recirculation step (c) is that it requires the addition of a further SM or NTU sensor at the sludge recirculation loop. Besides, the advantage of the recirculation step (a) with respect to the recirculation step (b) is the addition of a shorter hose to recirculate the plain settling sludge to the coagulation zone with respect to the hose of the abovementioned recirculation step (b). However, the drawback of the recirculation step (a) is that it requires the addition of a further SM or NTU sensor at the sludge recirculation loop.

In accordance with the invention, the operating period of the process in the third mode P3 can comprise:

a) passing raw water to be treated into a so-called coagulation zone in which a coagulation agent is present; and then

b) passing water from said coagulation zone into a so-called flocculation zone in which a flocculation agent is present and then

c) passing water from said flocculation zone into a so-called settling zone, and then

d) potentially a step of recirculating the settling sludge conditioned during the second mode P2 from said settling zone to said flocculation zone by an external circuit, said flocculation zone being located upstream of said settling zone.

For the purposes of the present invention, the raw water inlet zone is called a “feed zone”. The coagulation zone is the floc formation zone following the addition of coagulant. This zone is generally formed by a reactor receiving both raw water and coagulant. This zone is a volume (duct, channel, reactor) in which mixing and agitation can be ensured by dynamic mixers (propellers) by gas agitation or static mixers. The flocculation zone is the floc assembling zone by adding a flocculant. This zone is formed by an enclosure provided with a flocculator and receiving flocs from the coagulation zone and a flocculant. By way of example, stirred or static flocculators can be mentioned. The settling zone is the zone of separation between water and flocs; this zone comprises a water inlet and flocs from the flocculation zone, a sludge outlet circuit and a thickened sludge return circuit upstream of the settling zone.

Starting the second mode P2 or transition phase is made:

a) either on a flow rate threshold (fixed or depending on time during the day),

b) or on a flow rate increase threshold over a given time, represented by the derivative of the velocity with respect to time, which increase is higher in rainy weather (RW) than in dry weather (DW),

c) either by manual or automatic control from, for example, a signal from weather services and/or measurements made upstream in the sanitation system.

The graph of FIG. 2 shows strategies of starting the transition (analysis of the value and the derivative with respect to time of the raw water flow rate).

Depending on the system nature and the flow rate profile, the start logic can be adapted (also by self-learning of the data measured: real time analysis of the real flow rate profile with respect to the “typical” flow rate profile updated from the typical flow rate profiles of the previous days).

In the second mode P2 or transition phase within a first time,

either the plain settling primary sludge is recirculated to the coagulator feed, either directly to the coagulant zone via an external circuit (FIG. 1B) or at the inlet to the system feed via another external circuit (FIG. 1C) upstream of the coagulation zone 1 for conditioning with reagents, preferably of the coagulant type. The levels of coagulation and flocculation reagents are adapted accordingly, for example, by feedback control to the direct or indirect measurements of turbidity or SM content at the inlet of the coagulator (FIGS. 1B and 1C),

or the plain settling primary sludge is conditioned by injecting coagulation reagent in the sludge recirculation, via an external circuit of the settling zone to the flocculator/flocculating zone (FIG. 1D). The levels of coagulation and flocculation reagents are adapted accordingly, for example, by feedback control to a measurement representative of the turbidity or SM content of the sludge recovered at the bottom of the settling zone.

After a certain period of time between 30 minutes and 1 hour, either on the operator's decision, or after sending a signal by the system for measuring the quality of recirculated sludge (“conditioned sludge”) and if the turbidity of treated water is proper, then the system switches to the standard operating mode “with reagents” (P3).

In the standard third operating mode “with reagents” P3: raw water comes in the treatment system via the raw water inlet point, then it passes at least in the coagulation zones, in which a coagulant is injected, and then it passes at least in the flocculation zone, in which a flocculation agent is injected, and then it passes in the settling zone. At the outlet of the settling zone, at least one part of the sludge, which is conditioned after the second mode P2, is potentially recirculated via an external circuit to the flocculation zone (FIGS. 1B, 1C, 1D). It is to be noted that during the operating period of the third mode P3, in the embodiment of FIG. 1D, there is no injection of coagulation reagent in the recirculation loop of the external circuit (FIG. 1D).

Stopping the operating mode “with reagents”, the third mode P3 can be made:

either on a flow rate threshold (threshold being fixed or dependent on time during the day and an increase in flow rate, the whole for a given time and with the proviso that the third mode P3, has operated for a certain minimum fixed time,

or by manual control from the operator.

The positive impact of reconditioning the plain settling sludge in accordance with the invention is the possibility to work at a concentration optimum for which the solids loading is maximum, including during the transition phases: this point is the limit solids loading. This loading depends on the water nature and level of reagents (coagulant and flocculant). Indeed, one of the main criteria for dimensioning and exploiting sludge bed physico-chemical settlers is the solids loading (kg/m²/h), which reflects the ability of coagulated and flocculated suspended matter to settle, that is, the matter quantity that can pass through an area of 1 m² within 1 hour. Since this parameter depends on the concentration, if the concentration is low, the critical mass allowing an optimum settling velocity is not reached and the solids loading is low. On the other hand, for high concentrations, the solids loading decreases and settling is said to be slowed down.

In an advantageous embodiment of the invention, the first set of conditions C1 comprises:

a. a wastewater flow rate lower than a fixed flow rate threshold (this fixed flow rate threshold can be variable depending on time during the day, in the example of FIG. 2, the fixed flow rate threshold would be 23000 m³/h and the variable threshold would range from 14000 m³/h to 28000 m³/h),

b. an increase in flow rate over a given time (for example, 10 minutes) lower than a threshold value (on the example of FIG. 2, this threshold value would be 20%/h) and

c. the transition operating mode “with reagents” has not been manually activated.

If one at least of these conditions is not met, that is if the flow rate is higher than a flow rate set beforehand, or if over a given time, the increase in flow rate exceeds the threshold value, or if the transition operating mode “with reagents” is manually activated, then the process will switch to the second mode P2, the so-called transition mode.

In one advantageous embodiment of the invention, the second set of conditions C2 comprises:

a. a reconditioned recirculated sludge quality lower than a threshold value,

b. an operating time of the process in the transition phase P2 lower than a fixed threshold time and

c. the standard operating mode “with reagents” has not been manually activated.

If one at least of these conditions is not met, that is if the quality of sludge is higher than the threshold value, or if the operating time of the transition phase is higher than a fixed minimum time for this phase, or if the standard operation “with reagents” is manually activated, then the process will switch to the third mode P3.

In one advantageous embodiment of the invention, the third set of conditions C3 comprises:

a. a wastewater flow rate lower than a fixed flow rate threshold (this fixed flow rate threshold can be variable depending on time during the day), and an increase in flow rate over a given (for example, 10 minutes) lower than a threshold value, and an operating time in the standard mode “with reagents” higher than the operating time in the minimum standard mode “with reagents”

b. the operating “reagent-free” mode is manually activated.

If one of these conditions (a) or (b) is met, then the process will switch to the first mode P1 called a “reagent-free” mode.

Another object of the present invention is a sludge bed reactor for the primary treatment of urban or industrial wastewater comprising a ballasted floc physico-chemical settler, said settler at least consisting of a coagulation zone, a flocculation zone, a settling zone and an external circuit allowing sludge recirculation from the settling zone, said sludge recirculation being made:

a. either from the settling zone to the coagulation zone by an external circuit,

b. or from the settling zone to the raw water inlet point upstream of the measurement of turbidity (NTU) or suspended matter (SM) of said raw water by an external circuit,

c. or from the settling zone to the flocculation zone by an external circuit, said external circuit being provided with a coagulant injection system located between the outlet of the settling zone and the flocculation zone, said flocculation zone being located upstream of said settling zone.

In one particular embodiment of the invention, the reactor comprises a system for regulating the level of coagulation and flocculation agents, one or more systems for directly or indirectly measuring turbidity (NTU) or suspended matter (SM), said systems for measuring turbidity or suspended matter being placed at the inlet of the coagulator, and/or potentially at the settling zone, one or more systems for verifying the sets of conditions C1, C2 and C3 able to allow switching from the first mode P1 to the second mode P2, from the second mode P2 to the third mode P3, and from the third mode P3 to the first mode P1.

In one advantageous embodiment of the invention, the one or more systems for verifying the set of conditions C1, C2 and C3 is based, for example, either on a weather alert, or on a flow rate threshold corresponding to a fixed applied settling rate, or on a real time analysis of the real flow rate profile, with respect to the “typical” flow rate profile updated from typical flow rate profiles of the previous days, or on specified times, for example the minimum operating time and the stabilisation time.

In another embodiment, the reactor comprises:
a system for regulating the level of coagulation and flocculation agents taking the extra momentary sludge to be reconditioned into account; this level is made by any technique known to those skilled in the art, in particular by directly or indirectly measuring turbidity or suspended matter (SM) at the inlet of the coagulator possibly accompanied by a measurement representative of the content of SM of the sludge recovered at the bottom of the settling zone;
an early detection system for the necessity of switching to an operation with a higher flow rate, based on:
a weather alert,
a flow rate threshold corresponding to a fixed applied settling velocity,
a real time analysis of the real flow rate profile, with respect to the “typical” flow rate profile (for example, dry weather flow rate), updated from the typical flow rate profiles of the previous days;
a system for measuring sludge quality (“conditioned sludge” in FIG. 1) enabling the end of the second mode P2, a transition mode from the first “reagent-free” mode P1 to the third mode P3 “with reagents” to be determined beyond a simple specific time: this system connected to the sludge recirculation piping can be based, among other things, on the measurement of the ability of the sludge to properly settle (for example, on-line fall velocity coupled to a supernatant turbidity) and/or on the rate of conditioned sludge/total sludge (estimated for example by the metal/SM rate which reaches an asymptote when all the sludge has been conditioned);
a system for measuring the turbidity or SM of the treated water at the outlet of the settler enabling the device efficiency to be monitored.

The process according to the invention finds application in particular for the primary treatment of urban wastewater with and without addition of coagulation and flocculation reagents, in particular in the case of events with a strong flow rate variation (for example, rainy weather wastewater).

### DESCRIPTION OF THE FIGURES AND OF ONE EMBODIMENT OF THE INVENTION

Further advantages and characteristics of the invention will appear upon reading the detailed description of implementations and embodiments in no way limiting, and the following appended drawings:

FIG. 1: 1A: system of prior art comprising a feed zone (6), a coagulation zone (1) that can receive the coagulant by means of an injection system, a flocculation zone (2) that can receive a flocculant by means of an injection system and a settling zone (3) in which the settling is made. Part of the settled sludge possibly conditioned by adding reagents is removed by draining from the bottom of the settler, the other part is recirculated at the flocculation zone. 1B-1C: in these embodiments of the invention, the system comprises a feed zone (6), a coagulation zone (1) that can receive the coagulant by means of an injection system, a flocculation zone (2) that can receive the flocculant by means of an injection system and a settling zone (3) in which the settling is made. The recirculation of part of the sludge is directed either upstream of the coagulation zone by the duct (7a) (FIG. 1C) or to the coagulator (FIG. 1B) through the duct (5a) to condition the plain settling sludge, for example during the transition phase P2, or to the flocculator by the duct (5b). The latter embodiment corresponds to the normal steady state operation “with reagents” P3. This recirculation, irrespective of whether it is directed, ensures the presence of a sufficient contact mass in the flocculator to ensure flocculation. 1D: in this embodiment of the invention, the system comprises a feed zone (6), a coagulation zone (1) that can receive the coagulant by means of an injection system, a flocculation zone (2) that can receive a flocculant and a settling zone (3) in which the settling is made. The recirculation of part of the sludge is directed to the flocculator by the duct (5b) (FIG. 1D) and a system for injecting the coagulation reagent on the recirculation of the sludge (8) is placed between the settling zone and the flocculator. This injection can be either dedicated, or made by bypassing the main coagulant injection.

FIG. 2 represents the time change of the raw water flow rate as well as the relative increase in flow rate. It highlights two of the three starting modes of the transition phase P2:

flow rate higher than the fixed flow rate threshold (23000 m³/h) or variable over time (from 14000 m³/h to 28000 m³/h)

increase in the flow rate higher than 20%/h.

FIG. 3 represents the solids loading variation as a function of the sludge concentration for different types of sludge

curve (A): dry weather sludge with 30 mg/L ferric chloride

curve (B): rainy weather sludge with 45 mg/L ferric chloride

curve (C): DW-RW mixture has been made with sludge from dry weather water with plain settling and with rainy weather water with 30 mg/L ferric chloride

curve (D): DW-RW mixture has been made with sludge from dry weather water with plain settling and rainy weather water with 45 mg/L ferric chloride.

FIG. 4 represents the concentration of residual SM of the supernatant for different types of sludge:

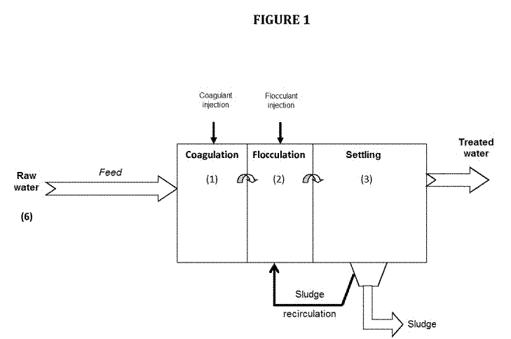

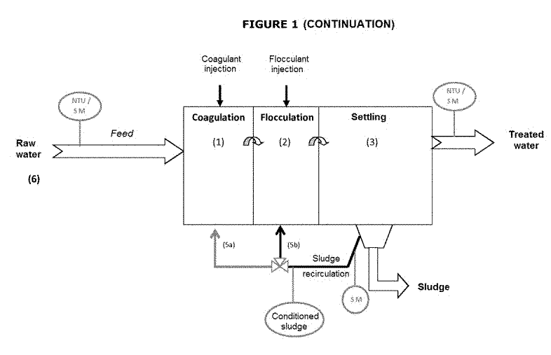

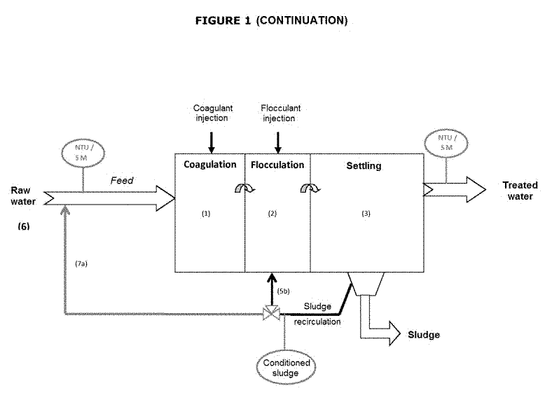

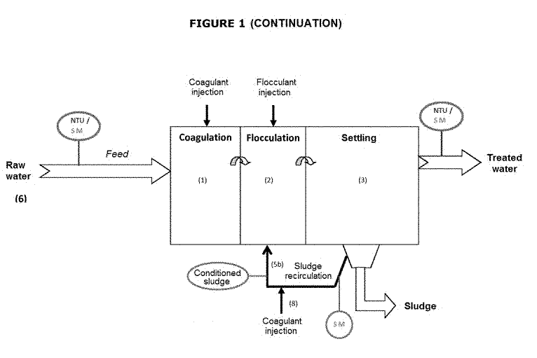

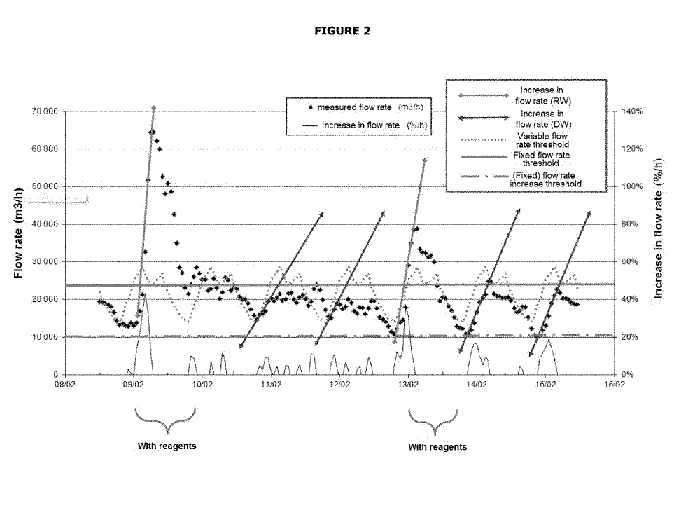

curve (A): dry weather sludge with 30 mg/L ferric chloride

curve (B): rainy weather sludge with 45 mg/L ferric chloride

curve (C): DW-RW mixture made with sludge from dry weather water with plain settling and with rainy weather water with 30 mg/L ferric chloride

curve (D): DW-RW mixture made with sludge from dry weather water with plain settling and rainy weather water with 45 mg/L ferric chloride.

One of the main criteria for dimensioning and exploiting sludge bed physico-chemical settlers is the solids loading (kg/m²/h), which reflects the ability of coagulated and flocculated suspended matter to settle: that is the matter quantity that can pass through an area of 1 m² within 1 hour. This parameter depends on the concentration: if the concentration is low, the critical mass allowing an optimum settling fall velocity is not reached and the solids loading is low. For high concentrations, the solids loading decreases, settling is said to be slowed down. There is a concentration optimum for which the solids loading is maximum: this point is the limit solids loading. This loading depends on water nature and level of reagents (coagulant and polymer).

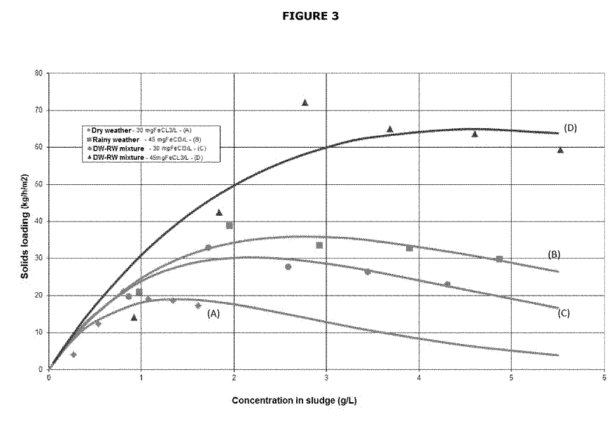

The process according to the invention has been simulated with two sewages from the same site taken on the same day, before and after the occurrence of a rainy weather. The dry weather-rainy weather (“DW-RW”) mixture has been made with sludge from dry weather water with plain settling and rainy weather water. The proportion of the mixture has been determined by simulating recirculation of the plain settling sludge to the coagulator, which corresponded to the equivalent of one dry weather volume for two rainy weather volumes. The best results are obtained with the DW-RW mixture implementing an over-level of ferric chloride (45 mg/L) for taking the “reconditioning” of settling sludge into account in addition of the SM of rainy weather water with a solids loading in the order of 60 kg/m²/h (FIG. 3).

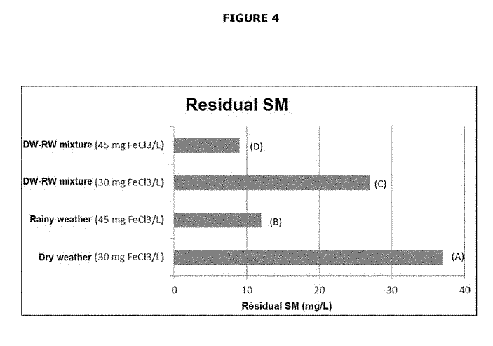

Since the purpose is to remove suspended matter, the process according to the invention enables performance to be improved. FIG. 4 shows the concentration of residual SM of the supernatant. Dry weather (DW) water has a concentration of residual SM much higher than rainy weather (RW) water. The DW-RW mixture with a low level of ferric chloride (30 mg/L) has an intermediate value. The DW-RW mixture implementing an over-level of ferric chloride (45 mg/L) for taking the “reconditioning” of the plain settling sludge into account in addition of the SM of the rainy weather water, has a concentration of residual SM lower than 10 mg/L.

Thus, the process according to the invention has the double advantage during transitions from a reagent-free operation to an operation with reagent of improving the solids loading and treated water quality.

Since the embodiments previously described are in no way limiting, alternatives of the invention could in particular be considered only comprising a selection of described characteristics, isolated from the other described characteristics (even if this selection is isolated within a sentence comprising these other characteristics), if this selection of characteristics is sufficient to provide a technical advantage or to discriminate the invention with respect to the state of the art. This selection comprises at least one characteristic, preferably a functional characteristic without structural details, or with only part of the structural details if this part only is sufficient to provide a technical advantage or to discriminate the invention with respect to the state of the art.

Naturally, the invention is not limited to the examples just described and numerous modifications could be provided to these examples without departing from the scope of the invention. Moreover, the different characteristics, forms, alternatives and embodiments of the invention can be associated with each other according to various combinations insofar as they are not incompatible or exclusive to each other.

1. A process for treating urban or industrial wastewater, in particular a process for the primary treatment of water, said process comprising a first operating mode P1 of the treatment system called a “reagent-free mode”, a second operating mode P2 of transition from the reagent-free mode P1 to a third mode P3, said third operating mode P3 of the treatment system being called a “mode with reagents”, switching from the first mode P1 to the second mode P2 being made after verifying a first set of conditions C1, switching from the second mode P2 to the third mode P3 being made after verifying a second set of conditions C2 and switching from the third mode P3 to the mode P1 being made after verifying a third set of conditions C3, the process being wherein the first mode P1 comprises:
a) passing raw water to be treated in a so-called coagulation zone (1) in which no coagulant is present, nor injected and then
b) passing water from said coagulation zone (1) into a so-called flocculation zone (2) in which no flocculation agent is present, nor injected and then
c) passing water from said flocculation zone (2) into a so-called settling zone (3), and then
d) potentially a step of recirculating the plain settling sludge from said settling zone (3) to said flocculation zone (2) by an external circuit (5b), said flocculation zone being located upstream of said settling zone (3),
and wherein the second mode P2 comprises:
a) either a step of recirculating the plain settling sludge from said settling zone (3) to said coagulation zone (1) by an external circuit (5a), said coagulation zone being located upstream of said settling zone (3) and said coagulation zone receiving a coagulant
b) or a step of recirculating the plain settling sludge from the settling zone (3) to the raw water inlet point (6) located upstream of the measurement of turbidity or suspended matter (SM) of said raw water by an external circuit (7a), said raw water inlet being located upstream of the coagulation zone receiving coagulant
c) or a step of recirculating the plain settling sludge from said settling zone (3) to said flocculation zone (2) by an external circuit (5b), said circuit (5b) being provided with a coagulant injection system (8) into said circuit (5b), said flocculation zone (2) being located upstream of said settling zone (3),
and wherein the third mode P3 comprises:
a) passing raw water to be treated into a so-called coagulation zone (1) in which a coagulation agent is present; and then
b) passing water from said coagulation zone (1) into a so-called flocculation zone (2) in which a flocculation agent is present and then
c) passing water from said flocculation zone (2) into a so-called settling zone (3), and then
d) potentially a step of recirculating the settling sludge conditioned during the second mode P2 from said settling zone (3) to said flocculation zone (2) by an external circuit (5b), said flocculation zone being located upstream of said settling zone (3).

2. The process according to claim 1, wherein among the parameters making up the conditions C1, C2 and C3, there are at least the measurement of the water flow rate and/or water quality and/or sludge quality and/or a signal from weather services and/or measurements made upstream in a sanitation system.

3. The process according to claim 1, further comprising a step of verifying the set of conditions C1, C2 and C3 enabling:
a. the process, when it is in the first mode P1 and that at least one of the conditions of the first set of conditions C1 is not verified, to switch to the second mode P2,
b. the process, when it is in the second mode P2 and that at least one of the conditions of the second set of conditions C2 is not verified, to switch to the third mode P3, and
c. the process, when it is in the third mode P3 and that one of the conditions of the set of conditions C3 is verified, to switch to the first mode P1.

4. The process according to claim 1, wherein the first set of conditions C1 comprises:
a. a wastewater flow rate lower than a fixed flow rate threshold, wherein said fixed flow rate threshold can be variable depending on time during the day,
b. an increase in flow rate over a given time, for example 10 minutes, lower than a threshold value,
c. the transition operating mode “with reagents” has not been manually activated.

5. The process according to claim 1, wherein the second set of conditions C2 comprises:
a. a reconditioned recirculated sludge quality lower than a threshold value,
b. a transition operating time lower than a fixed threshold time,
c. the standard operating mode “with reagents” has not been manually activated.

6. The process according to claim 1, wherein the third set of conditions C3 comprises:
a. a wastewater flow rate lower than a fixed flow rate threshold, wherein said fixed flow rate threshold can be variable depending on time during the day, and an increase in flow rate over a given time, for example 10 minutes, lower than a threshold value, and an operating time in the standard mode “with reagents” higher than the operating time in the minimum standard mode “with reagents”,
b. the operating “reagent-free” mode is manually activated.

7. A sludge bed reactor for the primary treatment of urban or industrial wastewater comprising a ballasted floc physico-chemical settler (2), said settler at least consisting of a coagulation zone (1), a flocculation zone (2), a settling zone (3) and an external circuit allowing sludge recirculation from the settling zone (3), said sludge recirculation being made:
a. either from the settling zone (3) to the coagulation zone (1) by an external circuit (5a),
b. or from the settling zone (3) to the raw water inlet point upstream of the measurement of turbidity or suspended matter of said raw water by an external circuit (7a),
c. or from the settling zone (3) to the flocculation zone (2) by an external circuit (5b), said external circuit (5b) being provided with a coagulant injection system (8) located between the outlet of the settling zone (3) and the flocculation zone (2), said flocculation zone being located upstream of said settling zone.

8. The reactor according to claim 7, further comprising a system for regulating the level of coagulation and flocculation agents, one or more systems for directly or indirectly measuring turbidity or suspended matter, said systems for measuring turbidity or suspended matter being placed at the inlet of the coagulator, and/or potentially at the settling zone, one or more systems for verifying the sets of conditions C1, C2 and C3 able to allow switching from the first mode P1 to the second mode P2, from the second mode P2 to the third mode P3, and from the third mode P3 to the first mode P1.

9. The reactor according to claim 8, wherein the one or more systems for verifying the set of conditions C1, C2 and C3 is based, for example, either on a weather alert, or on a flow rate threshold corresponding to a fixed applied settling rate, or on a real time analysis of the real flow rate profile, with respect to the “typical” flow rate profile updated from typical flow rate profiles of the previous days, or on specified times, for example the minimum operating time and the stabilisation time.

10. The process according to claim 2, further comprising a step of verifying the set of conditions C1, C2 and C3 enabling:
a. the process, when it is in the first mode P1 and that at least one of the conditions of the first set of conditions C1 is not verified, to switch to the second mode P2,
b. the process, when it is in the second mode P2 and that at least one of the conditions of the second set of conditions C2 is not verified, to switch to the third mode P3, and
c. the process, when it is in the third mode P3 and that one of the conditions of the set of conditions C3 is verified, to switch to the first mode P1.

11. The process according to claim 2, wherein the first set of conditions C1 comprises:
a. a wastewater flow rate lower than a fixed flow rate threshold, wherein said fixed flow rate threshold can be variable depending on time during the day,
b. an increase in flow rate over a given time, for example 10 minutes, lower than a threshold value,
c. the transition operating mode “with reagents” has not been manually activated.

12. The process according to claim 3, wherein the first set of conditions C1 comprises:
a. a wastewater flow rate lower than a fixed flow rate threshold, wherein said fixed flow rate threshold can be variable depending on time during the day,
b. an increase in flow rate over a given time, for example 10 minutes, lower than a threshold value,
c. the transition operating mode “with reagents” has not been manually activated.

13. The process according to claim 2, wherein the second set of conditions C2 comprises:
a. a reconditioned recirculated sludge quality lower than a threshold value,
b. a transition operating time lower than a fixed threshold time,
c. the standard operating mode “with reagents” has not been manually activated.

14. The process according to claim 3, wherein the second set of conditions C2 comprises:
a. a reconditioned recirculated sludge quality lower than a threshold value,
b. a transition operating time lower than a fixed threshold time,
c. the standard operating mode “with reagents” has not been manually activated.

15. The process according to claim 4, wherein the second set of conditions C2 comprises:
a. a reconditioned recirculated sludge quality lower than a threshold value,
b. a transition operating time lower than a fixed threshold time,
c. the standard operating mode “with reagents” has not been manually activated.

16. The process according to claim 2, wherein the third set of conditions C3 comprises:
a. a wastewater flow rate lower than a fixed flow rate threshold, wherein said fixed flow rate threshold can be variable depending on time during the day, and an increase in flow rate over a given time, for example 10 minutes, lower than a threshold value, and an operating time in the standard mode “with reagents” higher than the operating time in the minimum standard mode “with reagents”,
b. the operating “reagent-free” mode is manually activated.

17. The process according to claim 3, wherein the third set of conditions C3 comprises:
a. a wastewater flow rate lower than a fixed flow rate threshold, wherein said fixed flow rate threshold can be variable depending on time during the day, and an increase in flow rate over a given time, for example 10 minutes, lower than a threshold value, and an operating time in the standard mode “with reagents” higher than the operating time in the minimum standard mode “with reagents”,
b. the operating “reagent-free” mode is manually activated.

18. The process according to claim 4, wherein the third set of conditions C3 comprises:
a. a wastewater flow rate lower than a fixed flow rate threshold, wherein said fixed flow rate threshold can be variable depending on time during the day, and an increase in flow rate over a given time, for example 10 minutes, lower than a threshold value, and an operating time in the standard mode “with reagents” higher than the operating time in the minimum standard mode “with reagents”,
b. the operating “reagent-free” mode is manually activated.

19. The process according to claim 5, wherein the third set of conditions C3 comprises:
a. a wastewater flow rate lower than a fixed flow rate threshold, wherein said fixed flow rate threshold can be variable depending on time during the day, and an increase in flow rate over a given time, for example 10 minutes, lower than a threshold value, and an operating time in the standard mode “with reagents” higher than the operating time in the minimum standard mode “with reagents”,
b. the operating “reagent-free” mode is manually activated.

20. The process according to claim 15, wherein the third set of conditions C3 comprises:
a. a wastewater flow rate lower than a fixed flow rate threshold, wherein said fixed flow rate threshold can be variable depending on time during the day, and an increase in flow rate over a given time, for example 10 minutes, lower than a threshold value, and an operating time in the standard mode “with reagents” higher than the operating time in the minimum standard mode “with reagents”,
b. the operating “reagent-free” mode is manually activated.
